(19) United States
(12) Patent Application Publication
(10) Pub. No.: US 2024/0333015 A1
(43) Pub. Date: Oct. 3, 2024

(54) Method for Compensating for the Internal Resistance of an Energy Storage Device, and System for Compensating for the Internal Resistance

(71) Applicant: Robert Bosch GmbH, Stuttgart (DE)

(72) Inventors: Mickael Segret, Stuttgart (DE); Patrick Roeder, Herrenberg (DE); Christoph Klee, Stuttgart (DE); Andreas Gonser, Wolfschlugen (DE); Andreas Friese, Pfalzgrafenweiler (DE)

(21) Appl. No.: 18/579,999

(22) PCT Filed: Jun. 30, 2022
(86) PCT No.: PCT/EP2022/068039

§ 371 Date: Jan. 17, 2024

(30) Foreign Application Priority Data
Jul. 27, 2021 (DE) 10 2021 208 096.0

(51) Int. Cl. H02J 7/00; B25F 5/00; H01M 10/44; H01M 10/46

(52) U.S. Cl. CPC H02J 7/007194; H01M 10/443; H01M 10/46; H02J 7/00032; H02J 7/0047; H02J 7/0063; H02J 7/007182; B25F 5/00; H01M 2220/30

(57) ABSTRACT

A method for compensating for the internal resistance of an energy storage device, in particular an exchangeable replaceable battery pack, comprising at least one energy storage cell, in which the internal resistance is compensated for in an electric consumer or charging device, which is connected to the energy storage device, on the basis of an exponentially declining approximation, the curve of which depends on the temperature and the cell chemistry of the at least one energy storage cell. A system includes at least one energy storage device designed as an exchangeable replaceable battery pack and an electric consumer for discharging the exchangeable replaceable battery pack and/or a charging device for charging the exchangeable replaceable battery pack. The exchangeable replaceable battery pack, the electric consumer, and the charging device each has an electromechanical interface with a plurality of electric contacts for performing the method.

The invention relates to a method for compensating for an internal resistance of an energy storage device, as well as to a system for compensating for the internal resistance according to the preambles of the independent claims.

### THE PRIOR ART

A plurality of electric consumers are operated using rechargeable energy storage devices, which are discharged by the electric consumer and can be recharged by means of a charging device. Typically, such energy storage devices consist of a plurality of energy storage cells interconnected in series and/or parallel in order to achieve a required battery voltage or capacity. A particularly advantageous and quite high power and energy density can be achieved if the energy storage cells are designed as, e.g., lithium ion cells (Li-ion). However, such energy storage devices or energy storage cells are particularly sensitive to deep discharge, which can lead to their destruction. It is therefore necessary for the electric consumer to monitor the voltage of the energy storage device and prevent further discharging when a lower threshold voltage is reached.

Each energy storage device comprises an internal resistor, which is connected in series to an ideally resistance-free energy storage cell via a corresponding equivalent circuit diagram. If current is drawn from or supplied to the energy storage device, then a voltage also drops across this internal resistance. This unwanted voltage drop means that the electric consumer would switch off too early, even though the actual voltage of the energy storage device (OCV: Open Circuit Voltage) would still be sufficient for further operation. It is therefore known to compensate for the internal resistance of the energy storage device such that the electric consumer calculates the voltage drop across the internal resistance by means of a monitoring unit and derives a new switch-off threshold from this. However, it is problematic that the internal resistance depends very much on the temperature of the energy storage device or energy storage cells. The characteristic of the curve of the internal resistance over temperature is significantly influenced by the cell chemistry, which is different for different cell types.

In addition to a fixed integration of the energy storage device into the electric consumer, in particular for electric consumers with high power consumption and longer operating times, e.g. power tools, energy storage devices also exist which are designed as what are referred to as exchangeable replaceable battery packs. Via an electromechanical interface of the exchangeable replaceable battery pack, said devices can be coupled without the use of tools to a further electromechanical interface of the electric consumer or charging device. A respective first electric contact of the interfaces is in this case designed as an energy supply contact which can be supplied with a first reference potential, preferably a supply potential, and a respective second electric contact of the battery interfaces serves as an energy supply contact which can be supplied with a second reference potential, preferably a ground potential.

However, exchangeable replaceable battery packs can be equipped with very different energy storage cells having very different internal resistances and temperature characteristics. One solution is known from DE 102016209822.5, in which the internal resistance of an exchangeable replaceable battery pack is transmitted to the electric consumer via a third contact, designed as signal or data contact, of the electromechanical interfaces in dependence on a temperature measured in the exchangeable replaceable battery pack. Alternatively, the signal or data contact can also be used to estimate the internal resistance based on a coding resistance installed in the exchangeable replaceable battery pack and a look-up table stored in the electric consumer.

Based on the prior art, the object of the invention is to enable an improved cell- and temperature-dependent compensation for the internal resistance of an energy storage device, in particular an exchangeable replaceable battery pack, compared to the prior art, and thus to extend the operating time of the electric consumer or optimize the charging cycle of a charging device.

### Advantages of the Invention

In order to achieve this object, it is provided that the internal resistance is compensated for in an electrical consumer or charging device, which is connected to the energy storage device, on the basis of an exponentially declining approximation, the curve of which depends on the temperature and the cell chemistry of the at least one energy storage cell.

Compared to a solution using a coding resistor, this results in the advantage of a larger transferable amount of data for more precise estimation of the internal resistance in the electric consumer or in the charging device. In addition, no special design for an electronic module comprising the coding resistor and integrated into the energy storage device is necessary for individual adaptation to the characteristic of the energy storage cells used. A coding resistor is often designed to encode the smallest possible internal resistance of all energy storage cells usable for a particular energy storage cell type. In contrast, the method according to the invention offers the advantage that the calculation of the voltage drop does not have to be subject to an assumption with a certain degree of certainty, so that ultimately more power or capacity can be made available to the user. Compared to the direct transmission of the internal resistance value via the signal or data contact, this results in the advantage that the temperature is not measured in the energy storage device and must be calculated from a calculation unit there.

The method according to the invention is performed by a system consisting of at least one energy storage device designed as an exchangeable replaceable battery pack and an electric consumer for discharging the exchangeable replaceable battery pack and/or a charging device for charging the exchangeable replaceable battery pack. The exchangeable replaceable battery pack, the electric consumer and the charging device each has an electromechanical interface with a plurality of electric contacts. A first one of the electric contacts of the interface serves as an energy supply contact which can be supplied with a first reference potential, preferably a supply potential, a second one of the electric contacts of the interface serves as an energy supply contact which can be supplied with a second reference potential, preferably a ground potential, and a third one of the electrical contacts of the interface serves as a signal or data contact for transmitting the data required for calculating the exponentially declining approximation.

In the context of the invention, the term “electric consumers” is, e.g., understood to mean power tools that can be operated using an energy storage device, in particular an exchangeable replaceable battery pack, for machining workpieces by means of an electrically driven insertion tool. The power tool can in this case be designed both as a hand-held power tool, or also as a stationary electric machine tool. Typical power tools in this context include hand or bench drills, screwdrivers, percussion drills, hammer drills, planers, angle grinders, orbital sanders, polishing machines, circular saws, table saws, crosscut saws and jigsaws, or the like. However, garden and construction equipment operated using an energy storage device, in particular an exchangeable replaceable battery pack such as lawnmowers, lawn trimmers, branch saws, motor and ditching mills, robotic breakers and excavators, or the like, as well as household equipment operated with a replaceable battery pack such as vacuum cleaners, mixers, etc., can also be considered as electric consumers. The invention is likewise applicable to electric consumers which are simultaneously supplied using a plurality of exchangeable replaceable battery packs.

The voltage of an energy storage device is typically a multiple of the voltage of a single energy storage cell and results from the interconnection (parallel or in series) of the individual energy storage cells. An energy storage cell is typically designed as a galvanic cell comprising a structure in which a cell pole comes to rest on one end and another cell pole comes to rest on an opposite end. In particular, the energy storage cell comprises a positive cell pole at one end and a negative cell pole at an opposite end. Preferably, the energy storage cells are designed as lithium-based energy storage cells, e.g., Li-ion, Li-po, Li-metal, or the like. However, the invention can also be applied to energy storage devices comprising Ni—Cd cells, Ni—Mh cells, or other suitable cell types. In conventional Li-ion energy storage cells with a cell voltage of 3.6 V, voltage classes result of, e.g., 3.6 V, 7.2 V, 10.8 V, 14.4 V, 18 V, 36 V, etc. Preferably, an energy storage cells is designed as an at least substantially cylindrical round cell, the cell poles being arranged at ends of the cylindrical shape. However, the invention does not depend on the type and design of the energy storage cells used, but can instead be applied to any desired energy storage device and energy storage cells, e.g. pouch cells or the like, in addition to round cells.

In one embodiment of the invention, the exponentially declining approximation is designed to be below corresponding actual measured values of the at least one energy storage cell for a plurality, in particular for all, temperature values, of the at least one energy storage cell. It can thereby be ensured that the actual internal resistance is greater than or equal to the calculated values in order to enable a reliable compensation.

It is further provided that the exponentially declining approximation is calculated by means of at least two parameters, the at least two parameters characterizing the cell chemistry of the at least one energy storage cell. The at least two parameters for certain temperature values are stored in a look-up table of a memory of the energy storage device. In this way, a very accurate approximation of the internal resistance is possible on the one hand, whereas only little memory space is required in the memory of the energy storage device to store the parameters on the other hand.

In at least one method step of the method, the temperature of the energy storage device and/or the energy storage cell is measured, in which case a parameter value of each of the at least two parameters is transmitted to the electric consumer or the charging device depending on the measured temperature value. Particularly advantageously, the transmission capacity of the signal or data contact of the electromechanical interface can thereby be protected in order to optionally transmit further operating parameters or to verify the communication.

The method according to the invention provides that an approximation value of the internal resistance is calculated based on the at least two transmitted parameter values for the measured temperature value. In a further method step, a load current in the electric consumer or in the charging device is measured and a shutdown voltage is calculated based on the measured load current, the calculated approximation value, and a known open-circuit shutdown voltage of the energy storage cell using the following relationship:

$${U}_{Stop} = {U}_{StopOC} - {R}_{app} ( {T}_{i} ) * I$$

The known open-circuit shutdown voltage of the energy storage cell is in this case preferably 2.5 volts. Operation of the electric consumer or charging operation of the charging device is stopped when a measured cell voltage of the energy storage cell exceeds the calculated shutdown voltage.

The exponentially declining approximation can be calculated by three parameters characterizing the cell chemistry using the following relationship:

$${R}_{app} ( T ) = a * exp ( - b * T ) + c$$

To save memory space in the energy storage device, a first parameter ranges from 1 to 100, in particular from 20 to 50, a second parameter ranges from 0.01 to 0.1, in particular from 0.03 to 0.06, and a third parameter ranges from 1 to 60, in particular from 5 to 30. The dimension of the look up table can be minimized in this way.

In an alternative embodiment, it is provided that the exponentially declining approximation is formed by a plurality of straight lines, each straight line being defined by two parameter values, each resulting from a pair of values of a temperature value and the associated internal resistance of the energy storage cell. By using only two parameters, the effort involved in calculating the approximation in the electric consumer and/or the charging device can be further reduced. In addition, less memory space in the energy storage device and less bandwidth are required for the signal or data contact or the signal or data contact can be used to transmit further operating parameters. Particularly advantageously, the majority of straight lines are 2 to 100, in particular 3 to 7. Furthermore, the number of parameter values to be saved or transmitted can be reduced if one of the two parameter values of two adjacent straight lines is identical. Therefore, only N+1 parameter values are required for N straight lines. In one method step of the method, two associated parameter values are then selected from the look-up table based on the measured temperature value and an approximation value is calculated using the following relationship:

$${R}_{app} ( {T}_{i} ) = {R}_{n} + ( {R}_{n + 1} - {R}_{n} ) * ( {T}_{i} - {T}_{n} ) / ( {T}_{n + 1} - {T}_{n} )$$

In the alternative embodiment, it is also advantageously possible to approximate non-exponential curve profiles via the straight lines in order to be able to thereby take future cell chemistries with other temperature-dependent resistance curves into account.

### EXEMPLARY EMBODIMENTS

### Drawings

The invention is explained hereinafter with reference to FIGS. 1 through 6 by way of example, whereby identical reference characters in the drawings indicate identical components having an identical function.

Shown are:

FIG. 1: a schematic view of system comprising at least one energy storage device designed as an exchangeable replaceable battery pack and at least one charging device connectable to the exchangeable replaceable battery pack for charging, or an electric consumer connectable to the exchangeable replaceable battery pack for discharging the exchangeable replaceable battery pack,

FIG. 2: a block diagram of the system in FIG. 1,

FIG. 3: a diagram of an exponentially declining approximation of the internal resistance of the energy storage device according to the invention in a first embodiment,

FIG. 4: a flow chart of the method according to the invention in a first embodiment,

FIG. 5: a diagram of an exponentially declining approximation of the internal resistance of the energy storage device according to the invention in a second embodiment, and

FIG. 6: a flow chart of the method according to the invention in a second embodiment.

### DESCRIPTION OF THE EXEMPLARY EMBODIMENTS

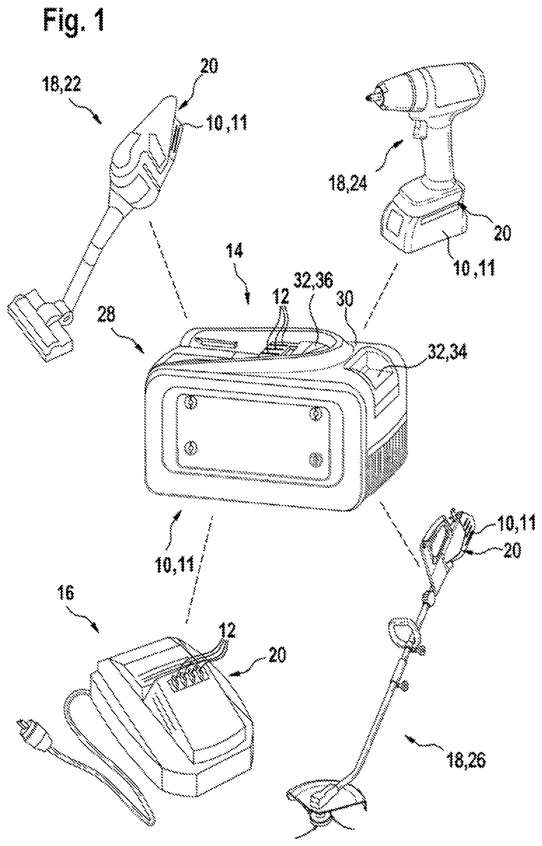

FIG. 1 shows an energy storage device 11 designed as an exchangeable replaceable battery pack 10 with an electromechanical interface 14 having a plurality of electric contacts 12. The exchangeable replaceable battery pack 10 can be charged by means of a charging device 16 and discharged by various electric consumers 18. To this end, the charging device 16 and the electric consumers 18 each comprise a further electromechanical interface 20 having a plurality of electric contacts 12. FIG. 1 is intended to illustrate that the invention is suitable for various electric consumers 18. By way of example, a battery vacuum cleaner 22, a battery impact wrench 24, and a battery lawn trimmer 26 are shown. However, in the context of the invention, a wide variety of power tools, garden tools, and household appliances can be suitable as electric consumers 18. In addition, the invention is equally applicable to electric consumers 18 which are supplied by an energy storage device 11 designed as an exchangeable replaceable battery pack 10 or as a permanently integrated battery (not shown).

The exchangeable replaceable battery pack 10 comprises a housing 28, a side wall or top side 30 of which comprises the electromechanical interface 14 for detachable connection with the further electromechanical interface 20 of the charging device 16 or the electric consumers 18. In connection with the electric consumer 18, the electromechanical interfaces 14, 20 are primarily used to discharge the exchangeable replaceable battery pack 10, whereas, in connection with the charging device 16, they are used in order to charge the exchangeable replaceable battery pack 10. The exact design of the electromechanical interfaces 14, 20 depends on various factors, e.g., the voltage class of the exchangeable replaceable battery pack 10, or of the electric consumer 18, and various manufacturer specifications. It is also possible to, e.g., provide three or more electric contacts 12 for energy and/or data transmission between the exchangeable replaceable battery pack 10 and the charging device 16. or the electric consumer 18. A mechanical coding means is also conceivable so that the exchangeable replaceable battery pack 10 can be operated only on specific electric consumers 18. Given that the mechanical design of the electromechanical interface 14 of the exchangeable replaceable battery pack 10 and of the further electromechanical interface 20 of the charging device 16 or the electric consumer 18 is irrelevant to the invention, it will not be addressed in further detail. Both the skilled person and a user of the exchangeable replaceable battery pack 10 and of the charging device 16, or rather the electric consumer 18, will make the appropriate selection in this respect.

The exchangeable replaceable battery pack 10 comprises a mechanical locking device 32 for locking the positively and/or non-positively detachable connection of the electromechanical interface 14 of the exchangeable replaceable battery pack 10 to the corresponding counter-interface 20 (not shown in detail) of the electric load 18. The locking device 32 is in this case designed as a spring-loaded push button 34 that is operatively connected to a locking element 36 of the exchangeable replaceable battery pack 10. Due to the resilience of the push button 34 and/or of the locking element 36, the locking device 32 automatically engages into the counter-interface 20 of the electric load 18 upon insertion of the exchangeable replaceable battery pack 10. If a user presses the push button 34 in the insertion direction, the locking is released and the user can remove or extend the exchangeable replaceable battery pack 10 from the electric consumer 18 in the direction opposite the insertion direction.

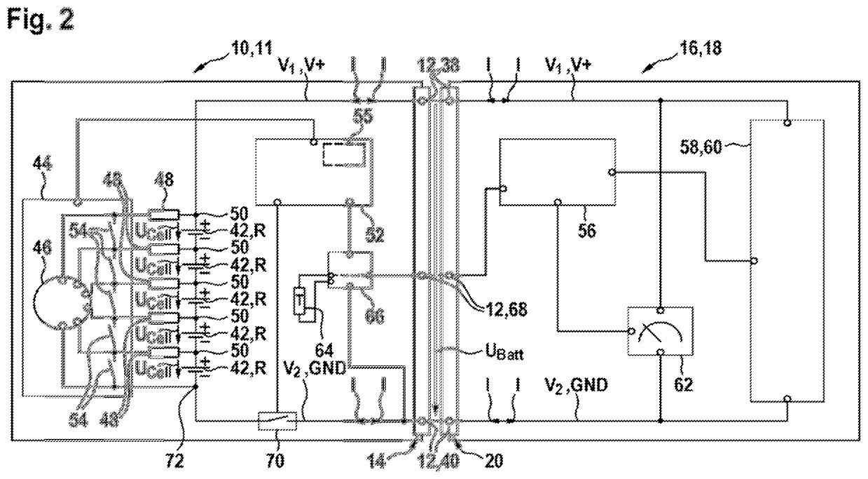

As previously mentioned hereinabove, the battery voltage of the exchangeable replaceable battery pack 10 generally results from a multiple of the individual voltages of the energy storage cells (see FIG. 2) as a function of their connection (in parallel or in series). The energy storage cells are preferably designed as lithium-based energy storage cells, e.g., Li-ion, Li-po, Li-metal, or the like. However, the invention can also be applied to exchangeable replaceable battery packs having Ni—Cd cells, Ni-MH cells, or other suitable cell types.

FIG. 2 shows a block diagram consisting of the energy storage device 11 designed as an exchangeable removable battery pack 10 on the left side and a charging device 16, or rather the electric consumer 18, on the right side. The exchangeable replaceable battery pack 10 and charging device 16 (or electric consumer 18) comprise the mutually corresponding electromechanical interfaces 14 and 20 having a plurality of electric contacts 12, a respective one first electric contact 12 of the interfaces 14, 20 serving as an energy supply contact 38 which can be supplied by a first reference potential V₁, preferably a supply potential V₊, and a respective one second electric contact 12 of the battery interfaces 14, 20 serving as an energy supply contact 40 which can be supplied by a second reference potential V₂, preferably a ground potential GND. Via the first and the second energy supply contacts 38, 40, the exchangeable replaceable battery pack 10 can, on the one hand, be charged by the charging device 16 with a charging current and, on the other hand, discharged by the electric consumer 18 with a discharging current. The current strengths of the charge and the discharging current can differ significantly from one another. The discharging current in correspondingly designed electric consumers 18 can be up to 10 times higher than the charging current of the charging device 16. Despite these differences between the charge and the discharge current, the following discussion will always refer to a load current I. The expression “can be supplied” is intended to clarify that the potentials V₊ and GND, in particular in the case of an electric consumer 18 that can be powered by an exchangeable replaceable battery pack 10, are not permanently applied to the energy supply contacts 38, 40 but are only applied after connecting the electrical interfaces 14, 20. The same is true of a discharged exchangeable replaceable battery pack 10 after connection to the charging device 16.

The exchangeable replaceable battery pack 10 comprises a plurality of energy storage cells 42, which are shown in FIG. 2 as a series circuit but can alternatively or additionally also be operated in a parallel circuit, in which case the series circuit defines the voltage U_{Batt} of the exchangeable replaceable battery pack 10 dropping across the energy supply contacts 38, 40, while a parallel circuit of individual energy storage cells 42 primarily increases the capacitance of the exchangeable replaceable battery pack 10. As previously mentioned hereinabove, it is also possible to connect in series individual cell clusters consisting of energy storage cells 42 connected in parallel in order to achieve a specific voltage U_{Batt} of the exchangeable replaceable battery pack with simultaneously increased capacitance. In conventional Li-ion energy storage cells 42 with a cell voltage U_{Cell} of 3.6 V each, an exchangeable replaceable battery pack voltage U_{Batt}=V₁−V₂ of 5·3.6 V=18 V drops across the energy supply contacts 38, 40 in the present exemplary embodiment. Depending on the number of energy storage cells 42 connected in parallel in a cell cluster, the capacitance of conventional exchangeable replaceable battery packs 10 can be up to 12 Ah or more. However, the invention is not dependent on the design, voltage, power supply capability, etc. of the energy storage cells 42 used, but can be used for any desired exchangeable replaceable battery pack 10 and energy storage cells 42.

A single-cell monitoring (SCM) pre-stage 44 is provided for monitoring the individual energy storage cells 42 connected in series, or the cell clusters of the exchangeable replaceable battery pack 10. The SCM pre-stage 44 comprises a multiplexer measuring device 46 which, via filter resistors 48, can be connected at a high impedance level to corresponding taps 50 of the poles of the energy storage cells 42 or cell clusters. The expression “energy storage cell” is also hereinafter intended to comprise the cell cluster since the former only influences the capacitance of the exchangeable replaceable battery pack 10, but have the same cell voltages U_{Cell}. The filter resistors 50, which are designed at a high impedance level, can in particular prevent dangerous heating of the measurement inputs of the multiplexer measuring device 46 in the event of a fault.

The switching of the multiplexer measuring device 46 can be performed via a monitoring unit 52 integrated into the exchangeable replaceable battery pack 10 or also directly within the SCM pre-stage 44. Additionally, switching elements 54 of the SCM pre-stage 44 connected in parallel to the energy storage cells 42 can in this way be closed or opened in order to thus effect what is referred to as balancing of the energy storage cells 42 in order to achieve uniform charge and/or discharge states of the individual energy storage cells 42. It is likewise conceivable that the SCM pre-stage 44 passes the measured cell voltages U_{Cell} to the monitoring unit 52 so that the actual measurement of the cell voltages U_{Cell} is performed directly by the monitoring unit 52, e.g., via a corresponding analog-digital converter (ADC).

The monitoring unit 52 can be designed as an integrated circuit in the form of a microprocessor, ASIC, DSP, or the like. It is likewise conceivable that the monitoring unit 52 consists of a plurality of microprocessors or at least in part of discrete components having corresponding transistor logic. In addition, the first monitoring unit 52 comprises a memory 55 for storing operating parameters of the exchangeable replaceable battery pack 10, such as the voltage U_{Batt}, the cell voltages U_{Cell}, a temperature T, the load current I, or the like.

In addition to the monitoring unit 52 in the replaceable battery pack 10, the charging device 16 or the electric consumer 18 also comprises a monitoring unit 56, which can be designed according to the monitoring unit 52 of the exchangeable replaceable battery pack 10. In the case of an electric consumer 18, the monitoring unit 56 controls a load 58 connected to the first and the second power supply contacts 38, 40 of the further interface 20, which is adjacent the exchangeable removable battery voltage U_{Batt}. The load 58 can, e.g., be designed as a power output stage that applies a pulse-width modulated signal to an electric motor to change its rotational speed and/or torque, which has a direct effect on the load current I of the exchangeable replaceable battery pack 10. However, a consumer 58 that converts power is also conceivable. Numerous variants of possible electrical or electromechanical loads are known to the skilled person, so this will not be addressed in further detail.

Alternatively, the replaceable battery pack 10 inserted into a charging device 16 can be charged at the load current I and the voltage U_{Batt} corresponding to the exchangeable replaceable battery pack 10. For this purpose, the charging device 16, or rather the power adapter 60 thereof, is provided with a grid connection (not shown). The voltage U_{Batt} applied to the energy supply contacts 38, 40 can be measured via a voltage measuring device 62 in the charging device 16 and evaluated by the monitoring unit 56. The voltage measuring device 62 can also be fully or partially integrated into the monitoring unit 56 of the charging device 16, e.g., in the form of an integrated ADC. The exact design of the mains adapter 60 of the charging device 16 is known to the skilled person and is of minor importance to the invention. Therefore, it will not to be further addressed herein.

A temperature sensor 64 arranged in the exchangeable replaceable battery pack 10, which is preferably designed as an NTC and is in close thermal contact with at least one of the energy storage cells 42, is used to measure a temperature T of the exchangeable replaceable battery pack 10 or the energy storage cells 42. The temperature T measured in this manner can be detected by means of a measuring circuit 66 integrated in the exchangeable replaceable battery pack 10 and evaluated by the monitoring unit 52 of the exchangeable replaceable battery pack 10. In addition or alternatively, the measured temperature T can also be transmitted to the charging device 16 or the electric consumer 18 for evaluation by means of the monitoring unit 56 via a contact 12 of the electromechanical interfaces 14, 20 designed as a signal or data contact 68.

In order to also interrupt or enable the load current I to increase the operational reliability within the exchangeable replaceable battery pack 10, the exchangeable replaceable battery pack 10 comprises at least a first switching element 70, which can be closed by the monitoring unit 52 for interrupting the load current I and opened for enabling the load current I. In the exemplary embodiment shown, the at least one first switching element 70 is arranged in the ground path (low side) between the second contact 12 designed as the power supply contact 40 of the electromechanical interface 14 and a ground contact point 62 of the SCM pre-stage 44. However, it is also conceivable that the at least one first switching element 70 be arranged in the supply path (high side) between the first contact 12 designed as the power supply contact 38 and the tap 50 of the SCM pre-stage 44 be designed as the supply contact point. Likewise, at least one first switching element 70 can be provided in both the supply path and the ground path. The at least one first switching element 70 is preferably designed as a MOSFET. However, other switching elements, such as a relay, an IGBT, a bipolar transistor, or the like, are also conceivable.

As previously mentioned hereinabove, the exchangeable replaceable battery pack 10 or its energy storage cells 42 have an internal resistance R, which leads to an unwanted voltage drop, so that the electric consumer 18 would switch off too soon, even though the open circuit voltage of the energy storage is still sufficient for further operation. Therefore, the internal resistance R of the exchangeable replaceable battery pack 10 must be compensated for such that the electric consumer 18 calculates the voltage drop U_{Cell} at the internal resistance R using the monitoring unit 56, taking into account a currently measured temperature value Tᵢ and the cell chemistry of the energy storage cell 42, and deriving a new shutdown voltage U_{Stop}.

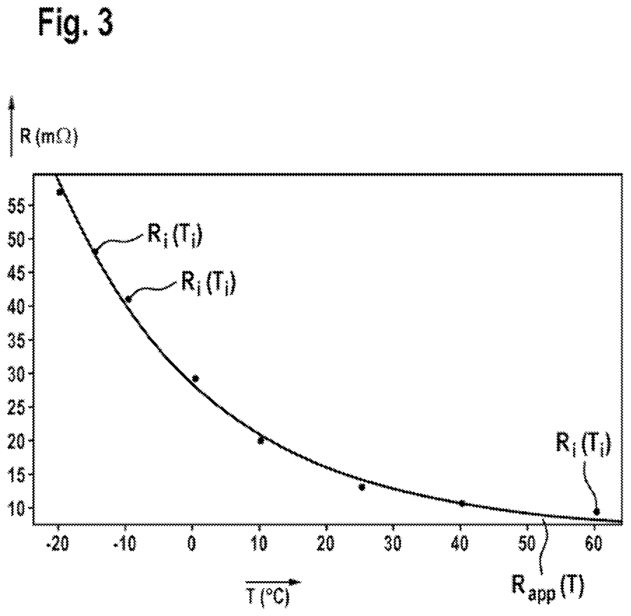

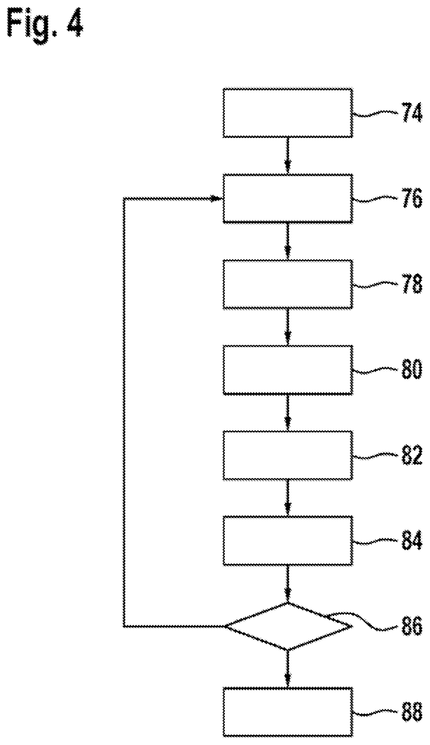

Explained hereinafter is a first exemplary embodiment of the method according to the invention for compensating for the internal resistance R of the exchangeable replaceable battery pack 10 based on FIGS. 3 and 4. The exchangeable replaceable battery pack 10 is in this case connected to the electric consumer 18 via the electromechanical interfaces 14, 20 in the manner described hereinabove. FIG. 3 shows exemplary the curve of the internal resistance R of a Li-Ion energy storage cell 42 over temperature T. The points in this case represent actual measured resistance values Rᵢ as a function of discrete temperature values Tᵢ, while the solid line represents a derived, exponentially declining approximation Rₐₚₚ(T), the curve of which depends on the temperature T and the cell chemistry of the energy storage cell 42.

The exponentially declining approximation Rₐₚₚ(T) can be calculated by three parameters (a, b, c) characterizing the cell chemistry using the following relationship:

$${R}_{app} ( T ) = a * exp ( - b * T ) + c$$

The three parameters (a, b, c) are stored in a look-up table in the memory 55 of the monitoring unit 52 of the exchangeable replaceable battery pack 10 for individual temperature values Tᵢ. To save memory space, preferably the first parameter a ranges from 1 to 100, in particular from 20 to 50, the second parameter b ranges from 0.01 to 0.1, in particular from 0.03 to 0.06, and the third parameter c ranges from 1 to 60, in particular from 5 to 30. The dimension of the look-up table can therefore be minimized accordingly.

In addition, with a measured temperature value Tᵢ, which does not exist directly in the look-up table, it is possible to use the parameter values aᵢ, bᵢ, cᵢ for the next lower stored temperature value Tᵢ. In this way, it is ensured that the exponentially declining approximation Rₐₚₚ(T) is below the actual measured values of the internal resistance R(Tᵢ) of the at least one energy storage cell 42 for a plurality of the temperature values Tᵢ, such that the actual internal resistance Rᵢ(Tᵢ) is greater than or equal to the calculated approximation values Rₐₚₚ(Tᵢ) to enable reliable compensation. However, the parameter values aᵢ, bᵢ, cᵢ can also be selected from the outset so that the approximate values Rₐₚₚ(Tᵢ) calculated are always below the actual measured values of the internal resistance Rᵢ(Tᵢ) for all temperature values Tᵢ. In other words, the line shown in FIG. 3 then shifts downward by a certain offset.

FIG. 4 shows a flow chart of the method based on the exponentially declining approximation Rₐₚₚ(T) shown in FIG. 3. In a first method step 74, an operating mode is first set on the electric consumer 18 and the electric consumer 18 is started. In the following method step 76, communication is established with the exchangeable replaceable battery pack 10 via the signal or data contact 68 of the electromechanical interfaces 14, 20 and the temperature T of the exchangeable replaceable battery pack 10 and/or the at least one energy storage cell 42 is measured by means of the temperature sensor 64 and the measuring device 66. In method step 78, the three parameters a, b, c stored in the memory 55 of the exchangeable replaceable battery pack 10 are then queried and, depending on the measured temperature value Tᵢ, an associated parameter value aᵢ, bᵢ, cᵢ of the three parameters a, b, c is transmitted to the electric consumer 18. Based on the three parameter values aᵢ, bᵢ, cᵢ transmitted, the approximation value Rₐₚₚ(Tᵢ) of the internal resistance (R) for the measured temperature value Tᵢ is then calculated by means of the monitoring unit 56 in method step 80.

It is also conceivable that method steps 76 and 78 can be swapped. In this case, in method step 76, communication is first established between the electric consumer 18 and the exchangeable replaceable battery pack 10 via the signal or data contact 68 in order to transmit all parameter values aᵢ, bᵢ, cᵢ of the three parameters a, b, c stored in the look-up table of the memory 55 to the monitoring unit 56 of the electric consumer 18. In the following method step 78, the temperature T of the exchangeable replaceable battery pack 10 or the at least one energy storage cell 42 is first measured and the measured temperature value Tᵢ is transmitted via the signal or data contact 68 to the monitoring unit 56 of the electric consumer 18, so that the monitoring unit 56 subsequently selects the associated parameter value aᵢ, bᵢ, cᵢ.

In method step 82, the electric consumer 18 measures the load current I by means of the monitoring unit 56 and calculates the shutdown voltage U_{Stop} by means of the measured load current I, the approximation value Rₐₚₚ(Tᵢ) calculated in method step 80, and a known open-circuit shutdown voltage U_{StopOC} of energy storage cell 42 by means of the following relationship:

$${U}_{Stop} = {U}_{StopOC} - {R}_{app} ( {T}_{i} ) * I$$

in the following method step 84. The known open-circuit shutdown voltage U_{StopOC} of the energy storage cell 42 can in this case be, e.g., 2.5 volts. However, different open-circuit shutdown voltages U_{StopOC} are conceivable depending on the type and cell chemistry of the energy storage cell 42.

In method step 86, a decision is then made as to whether or not operation of the electric consumer 18 must be stopped. If the measured cell voltage U_{Cell} of the energy storage cell 42 exceeds the calculated shutdown voltage U_{Stop}, then the electric consumer 18 is switched off in method step 88. Otherwise, method step 76 is returned to and the temperature T is measured again until the electric consumer 18 is switched off by the operator.

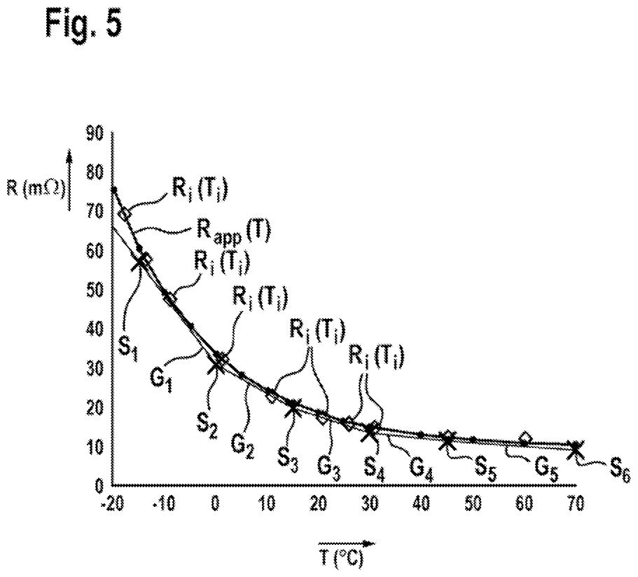

Calculation of an exponential function may or may not be difficult to implement, in particular in electric consumers 18 or charging devices 16 comprising a monitoring unit 56 with lower performance. As a result, in an alternative embodiment shown in the following FIG. 5, the method according to the invention provides that the exponentially declining approximation Rₐₚₚ(T) is formed by a plurality N of straight lines Gn, in which case each straight line Gn is defined by two parameter values Sₙ(Tₙ, Rₙ), Sₙ₊₁(Tₙ₊₁, Rₙ₊₁), each of which results from a pair of values of a temperature value Tₙ, Tₙ₊₁ and the associated internal resistance Rₙ, Rₙ₊₁ of the energy storage cell 42. In the exemplary embodiment shown in FIG. 5, the exponentially declining approximation Rₐₚₚ(T) is thus formed by a total of N=5 straight lines G₁, . . . , G₅ with the support points S₁(T₁,R₁), . . . , S₆(T₆,R₆). A support point S₂(T₂,R₂), . . . , S₅(T₅,R₅) of two adjacent straight lines G₁, . . . , G₅ is identical, so that the straight lines G₁, . . . , G₅ intersect at these support points S₂(T₂,R₂), . . . , S₆(T₅,R₅). In order to calculate the temperature-dependent compensation for the internal resistance R over N straight lines, only N+1 support points must be stored in the memory 55 of the exchangeable replaceable battery pack 10 or transmitted to the electric consumer 18 or the charging device 16. Furthermore, the memory requirement in the memory 55 of the exchangeable replaceable battery pack 10 and the power requirement for the monitoring unit 56 of the electric consumer 18 or the charging device 16 can be kept as low as possible when the plurality N of straight lines Gₙ is limited to between 2 and 100, particularly preferably to between 3 and 7.

It is particularly advantageous if the support points Sₙ (Tₙ, Rₙ), Sₙ₊₁(Tₙ₊₁, Rₙ₊₁) are designed such that the calculated straight lines Gₙ at all measured temperature values Tᵢ always run below the actual internal resistance values Rᵢ of the energy storage cells 42. It is thereby ensured that the internal resistance R is always greater than or equal to the calculated values in order to achieve reliable compensation. A further advantage of the second embodiment is that non-exponential curve profiles can also be approximated over the straight lines Gn, so that future cell chemistries with possibly different temperature-dependent resistance curves can also be taken into account.

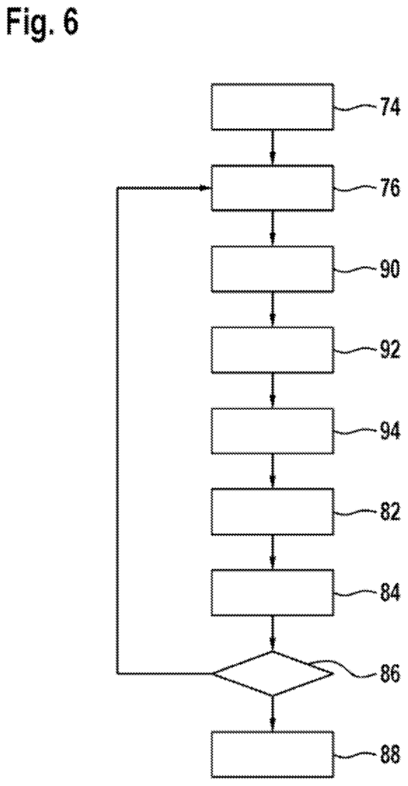

FIG. 6 shows a flow chart of the second embodiment of the method according to the invention for compensation for the internal resistance R of the exchangeable replaceable battery pack 10 and the at least one energy storage cell 42. The method steps identical to the first exemplary embodiment shown in FIGS. 3 and 4 have the same reference characters.

In the first method step 74, an operating mode is again initially set on the electric consumer 18 and the electric consumer 18 is started. In method step 76, the electric consumer 18 then establishes communication with the exchangeable replaceable battery pack 10 via the signal or data contact 68 of the electromechanical interfaces 14, 20 in order to measure the temperature T of the exchangeable replaceable battery pack 10 or the at least one energy storage cell 42 by means of the measuring device 66 and the temperature sensor 64 and to transmit the measured temperature value Tᵢ to the monitoring unit 56 of the electric consumer 18 via the signal or data contact 68. In method step 90, the two support points Sn (Tₙ, Rₙ), Sₙ₊₁(Tₙ₊₁, Rₙ₊₁) belonging to the corresponding temperature window Tₙ, Tₙ₊₁ in the memory 55 of the exchangeable replaceable battery pack 10 are selected from the look-up depending on the measured temperature Ti and transmitted to the electric consumer 18. Based on the two transmitted support points Sₙ(Tₙ, Rₙ), Sₙ₊₁(Tₙ₊₁, Rₙ₊₁) and the measured temperature value Tᵢ, the approximation value Rₐₚₚ(Tᵢ) of the internal resistance (R) is then calculated in method step 92 by means of the monitoring unit 56 and linear interpolation using the following relationship:

$${R}_{app} ( {T}_{i} ) = {R}_{n} + ( {R}_{n + 1} - {R}_{n} ) * ( {T}_{i} - {T}_{n} ) / ( {T}_{n + 1} - {T}_{n} )$$

Similar to the first exemplary embodiment, the order of the two method steps 76 and 90 can also be swapped in this case.

In the latter case, communication is first established in method step 76 between the electric consumer 18 and the exchangeable replaceable battery pack 10 via the signal or data contact 68 in order to transmit all of the support points S₁(T₁, R₁), S_{N+1}(T_{N+1}, R_{N+1}) stored in the look-up table of the memory 55 to the monitoring unit 56 of the electric consumer 18. In the following method step 90, the temperature T of the exchangeable replaceable battery pack 10 or the at least one energy storage cell 42 is first measured and the measured temperature value Tᵢ is transmitted to the monitoring unit 56 of the electric consumer 18 via the signal or data contact 68. In method step 92, the monitoring unit 56 selects an associated temperature window Tₙ, Tₙ₊₁ based on the transmitted temperature value Tᵢ in order to calculate the approximation value Rₐₚₚ(Tᵢ) according to the above linear interpolation in method step 94 based on the associated support points Sₙ(Tₙ, Rₙ), Sₙ₊₁(Tₙ₊₁, Rₙ₊₁).

The following method steps (82 to 88) are then identical to the method of the first embodiment shown in FIG. 4. In method step 82, the electric consumer 18 measures the consumer current I by means of the monitoring unit 56 and calculates the shutdown voltage U_{Stop} by means of the measured load current I, the approximation value Rₐₚₚ(Tᵢ) calculated in method step 94, and a known open-circuit shutdown voltage U_{StopOC} of the energy storage cell 42 using the following relationship in the following method step 84:

$${U}_{Stop} = {U}_{StopOC} - {R}_{app} ( {T}_{i} ) * I$$

In method step 86, a decision is made as to whether operation of the electric consumer 18 must be stopped or not in method step 88. If operation need not to be stopped, then the method returns to method step 76 in order to measure the temperature T until the electric consumer 18 is switched off by the operator.

Finally, it should be noted that the exemplary embodiments shown are not limited to FIGS. 1 to 6, nor to the type of replaceable battery packs 10, charging devices 16, or electric consumers 18 shown therein. The same applies to the number of energy storage cells 46 and the associated design of the multiplexer measuring device 46. In addition, the embodiments of the interfaces 14, 20 and the number of their contacts 12 shown are merely to be understood by way of example. This also applies to the type and number of temperature sensors, switching means, monitoring units, etc.

1. A method for compensating for the internal resistance of an exchangeable replaceable battery pack, compromising at least one energy storage cell, the method comprising:
compensating for an internal resistance in an electric consumer or charging device, which is connected to the energy storage device, on the basis of an exponentially declining approximation, the curve of which depends on a temperature and the cell chemistry of the at least one energy storage cell.

2. The method according to claim 1, wherein the exponentially declining approximation for each measured temperature value is below corresponding actual measured values of the internal resistance of the at least one energy storage cell.

3. The method according to claim 1, further comprising:
calculating the exponentially declining approximation using at least two parameters, wherein
the at least two parameters characterize the cell chemistry of the at least one energy storage cell.

4. The method according to claim 3, further comprising:
storing the at least two parameters for certain of the temperature values in a look-up table of a memory of the energy storage device.

5. The method according to claim 3, further comprising:
measuring the temperature of the energy storage device and/or the at least one energy storage cell; and
transmitting, depending on the measured temperature value, a parameter value of the at least two parameters to the electric consumer or the charging device.

6. The method according to claim 3, further comprising:
calculating an approximation value of the internal resistance for the measured temperature value based on the at least two parameter values.

7. The method according to claim 3, further comprising:
measuring a load current in the electric consumer or the charging device; and
calculating, based on the measured load current), the calculated approximation value, and a known open-circuit shutdown voltage of the energy storage cell, a shutdown voltage using the following relationship:
$${U}_{Stop} = {U}_{StopOC} - {R}_{app} ( {T}_{i} ) * I ,$$
wherein
U_{Stop} is the shutdown voltage,
U_{StopOC} is the known open-circuit shutdown voltage,
Rₐₚₚ(Tᵢ) is the calculated approximation value, and
I is the measured load current.

8. The method according to claim 7, wherein the known open-circuit shutdown voltage of the energy storage cell is 2.5 volts.

9. The method according to claim 7, further comprising:
stopping the operation of the electric consumer or the charging operation of the charging device when a measured cell voltage of the energy storage cell exceeds the calculated shutdown voltage.

10. The method according to claim 1, wherein the exponentially declining approximation is calculated using three parameters (a, b, c) characterizing cell chemistry using the following relationship:
$${R}_{app} ( T ) = a * exp ( - b * T ) + c ,$$
wherein
Rₐₚₚ(T) is the exponentially declining approximation, and
“T” is the temperature of the at least one energy storage cell.

11. The method according to claim 10, wherein:
the parameter “a” ranges from 20 to 50;
the parameter “b” ranges from 0.03 to 0.06; and
the parameter “c” ranges from 5 to 30.

12. The method according to claim 1, wherein:
the exponentially declining approximation is formed by a plurality of straight lines; and
each straight line is defined by two parameter values, which each result from a pair of values including a temperature value and an associated internal resistance of the energy storage cell.

13. The method according to claim 12, wherein the plurality of straight lines is 3 to 7.

14. The method according to claim 12, wherein one of the two parameter values of two adjacent straight lines is identical.

15. The method according to claim 12, wherein two associated parameter values, are selected from a look-up table based on a measured temperature value (Tᵢ) and an approximation value Rₐₚₚ (Tᵢ) using the following relationship:
$${R}_{app} ( {T}_{i} ) = {R}_{n} + ( {R}_{n + 1} - {R}_{n} ) * ( {T}_{i} - {T}_{n} ) / ( {T}_{n + 1} - {T}_{n} ) ,$$
wherein
“Rₙ” is the associated internal resistance.

16. A system configured to perform the method of claim 3, comprising:
at least one energy storage device designed as an exchangeable replaceable battery pack; and
at least one of an electric consumer configured to discharge the exchangeable replaceable battery pack and a charging device configured to charge the exchangeable replaceable battery pack, the exchangeable replaceable battery pack, the at least one of the electric consumer, and the charging device having an electromechanical interface with a plurality of electric contacts used in performing the method of claim 3,
wherein
a first one of the plurality of electric contacts of the interfaces is an energy supply contact configured to be supplied by a first reference potential in the form of a supply potential,
a second one of the plurality of electric contacts of the interfaces is an energy supply contact configured to be supplied by a second reference potential in the form of a mass potential, and
a third one of the plurality of electric contacts of the interfaces is configured as a signal or data contact to transmit the at least two parameters.
